(19) United States
(12) Patent Application Publication
(10) Pub. No.: US 2007/0023558 A1
(43) Pub. Date: Feb. 1, 2007

(54) Load limiter for seat belt retractor

(75) Inventor: Todd Humbert, Maricopa, AZ (US)

Correspondence Address: MAYER, BROWN, ROWE & MAW LLP, P.O. BOX 2828, CHICAGO, IL, 60690-2828, US

(73) Assignee: AMSAFE, INC.

(21) Appl. No.: 11/191,744

(22) Filed: Jul. 27, 2005

(51) Int. Cl. B60R 22/36

(52) U.S. Cl. 242/382

(57) ABSTRACT

An improved belt retractor assembly for use in a seat belt safety mechanism having a frame, a belt spool rotatably mounted on the frame, a pawl mounted for rotation with the spool, the retractor assembly including a calibration plate for mounting on the frame and a ratchet wheel mounted on the calibration plate by interference fit for engagement with the pawl. During an accident event, the belt retractor assembly will allow the spool to dispense belt webbing when the belt load goes above a predetermined range, thus allowing an occupant to incur lower overall loads.

### FIELD OF INVENTION

The present invention relates generally to seat belt retractors and more particularly seat belt retractors that contain load limiting functionality.

### BACKGROUND OF INVENTION

As is known in the art, seat restraints for vehicles such as aircraft and automobiles use a belt webbing to restrain a seat occupant. When the belt webbing is buckled and adjusted over the waist and/or shoulders of the seat occupant, the seat restraint system holds the occupant in his/her seat during sudden decelerations of the aircraft or automobile caused by collisions or other accidents.

In a typical restraint system, the belt webbing is wrapped about an inertia reel within a seat retractor assembly. Conventional seat belt retractors typically comprise a frame with a spool rotationally mounted in or on the frame, which spool contains the seat belt webbing wound around the spool. The spool will also typically contain a locking mechanism, such as a locking pawl that is designed to engage locking teeth attached to the frame in the event of an accident, thereby preventing the belt webbing from being released from the spool. In addition to this functionality of the belt retractor (i.e., to prevent belt webbing from unwinding from the spool in the event of an accident), many belt retractors contain so-called load limiting or energy absorbing features, which under certain circumstances allow the belt webbing to unwind from the spool, even when the spool is in a locked position. This functionality is provided to limit the loads placed on an occupant during an accident, with the aim of reducing injury to the occupant and reducing the load on the seat frame to which the belt retractor is typically secured. Indeed, in some accidents, the load applied to an occupant through the belt webbing can lead to broken bones in the chest and pelvis areas and other injuries.

In order to achieve such load-limiting functionality, it has been known to provide a deformable member, such as a torsion bar, in the belt retractor assembly. With such deformable members, in the event of an accident, the torsion bar will be rotated beyond its elastic limit into its plastic deformation range, which allows the belt webbing to unwind and theoretically apply a constant force to the occupant. However, a problem with the torsion bar approach to providing load limiting functionality to a belt retractor is that after a given number of revolutions, the bar will yield and fracture, thereby allowing the remainder of the belt webbing to unwind at zero load. Moreover, with a torsion bar, after one accident the retractor assembly should be replaced, even if the torsion bar does not fracture, in order to restore the belt retractor (and the torsion bar) to its original specifications and physical characteristics. Accordingly, there is a need for an improved belt retractor assembly having load-limiting features.

Other needs will become apparent upon a further reading of the following detailed description taken in conjunction with the drawings.

### SUMMARY OF THE INVENTION

One embodiment of the present invention comprises an improved belt retractor assembly for use in a seat belt safety mechanism having a frame, a belt spool rotatably mounted on the frame, a pawl mounted for rotation with the spool, the retractor assembly including a calibration plate for mounting on the frame and a ratchet wheel mounted on the calibration plate by interference fit for engagement with the pawl.

### BRIEF DESCRIPTION OF THE DRAWINGS

FIG. 1 is a front perspective view of one embodiment of a belt retractor of the present invention.

FIG. 2 is a cross-section view a belt retractor of the present invention, taken along line 2-2 of FIG. 1.

FIG. 3 is an exploded view of the belt retractor of FIG. 1.

FIG. 4 is a perspective view of a calibration ring of one embodiment of the present invention.

FIG. 5 is a perspective view of a ratchet wheel of one embodiment of the present invention.

FIG. 6 is a front perspective view of the belt retractor of FIG. 1, with the locking pawl mechanism removed therefrom illustrative purposes.

### DETAILED DESCRIPTION OF THE PREFERRED EMBODIMENT

While the present invention is capable of embodiment in various forms, there is shown in the drawings and will be hereinafter described a presently preferred embodiment with the understanding that the present disclosure is to be considered as an exemplification of the invention, and is not intended to limit the invention to the specific embodiment illustrated.

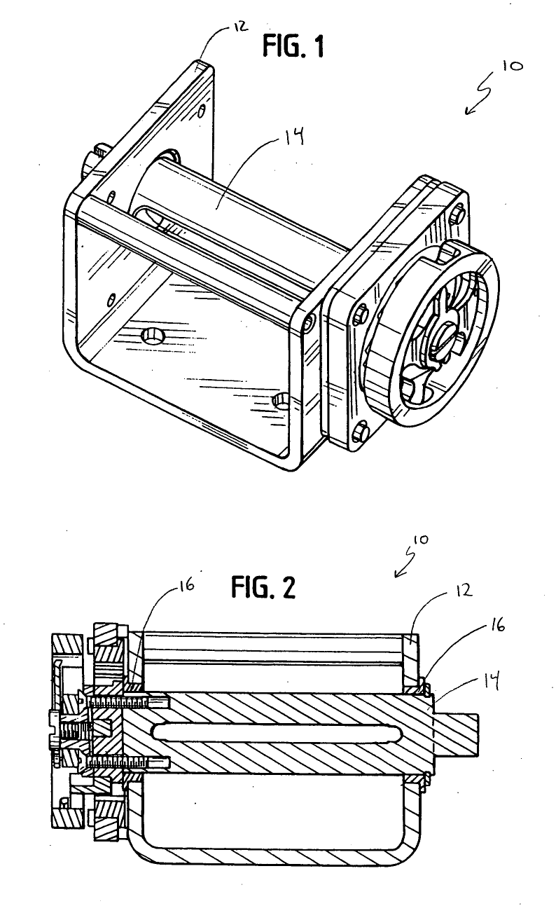

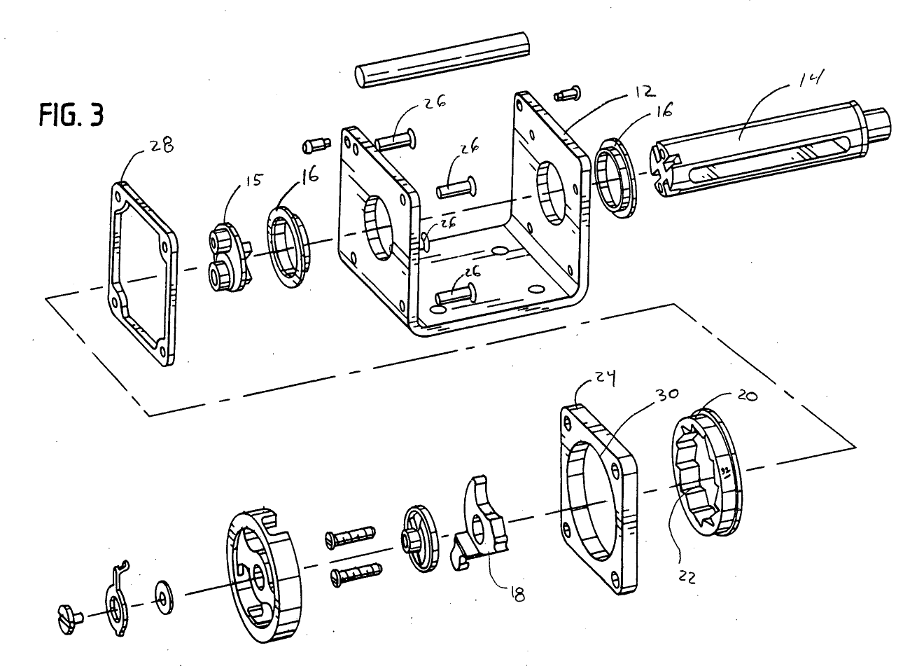

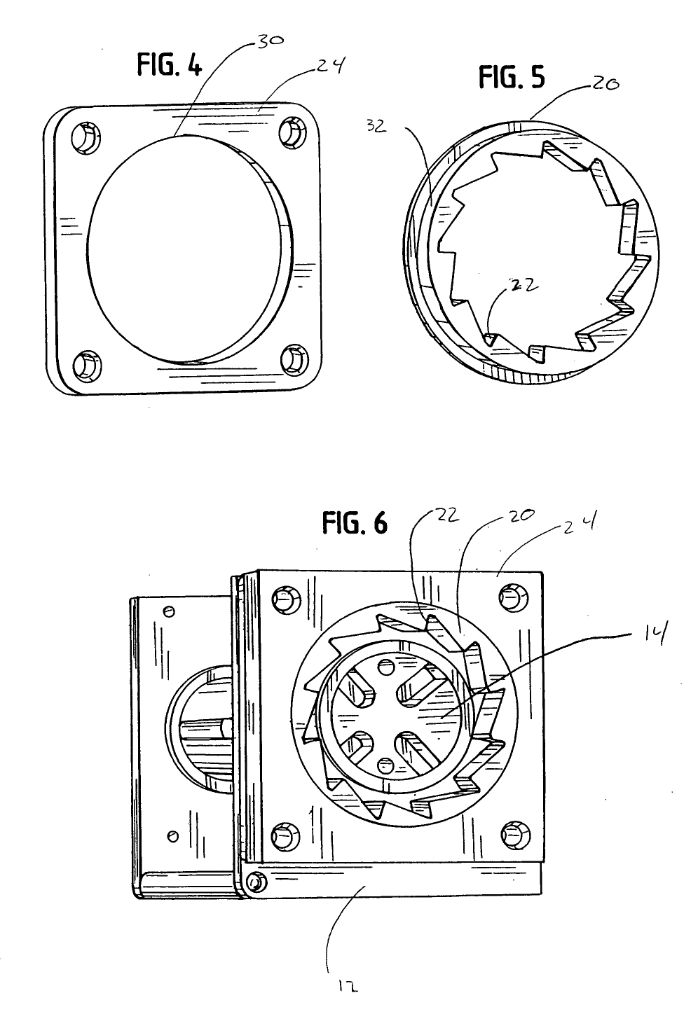

With reference to FIGS. 1-6, one embodiment of the present invention comprises a belt retractor assembly, generally designated as reference numeral 10, which includes a frame 12 and a spool 14 that is rotatably coupled to the frame 12 via bearings 16. As is known in the art a belt webbing (not shown) is wound around the spool 14. A locking pawl 18 is attached to the spool 14 via a shaft cap 15 in a manner that allows the pawl to engage a ratchet wheel 20 upon the occurrence of an accident. The precise manner in which the locking pawl 18 engages the ratchet wheel 20 is well known in the art and will not be discussed herein in detail. Suffice it to say that the upon the occurrence of an accident, the locking pawl 18 will engage with one of the teeth 22 on the ratchet wheel 20 to halt the rotation of the spool 14 and the protraction of the belt webbing. Typically the locking pawl 18 will be caused to engage one of the teeth 22 through the use of a vehicle or inertia sensor to sense vehicle deceleration above a predetermined level and/or a web sensor that detects when belt webbing is withdrawn from the spool in a rate in excess of a predetermined rate. It will be understood that that are a variety of locking arrangements for belt retractors known in the art and that any of such locking arrangements can be used in the practice of the present invention. Without limiting the foregoing, it will be appreciated that although a preferred embodiment of the present invention contains a reel 14 having a pawl 18 attached thereto for engagement with a ratchet wheel 20 that is attached to the frame, the principles of the present invention are applicable to a belt retractor that contains a reel with a ratchet wheel attached thereto, wherein the ratchet wheel engages with a pawl mounted to the frame.

In one embodiment of the invention, the ratchet wheel 20 is attached to a calibration ring 24, which calibration ring 24 is then attached to the frame 12 via a suitable fastener, which in a preferred embodiment are rivets 26. It will be appreciated that any type of fastener or other attachment means can be used to attach calibration ring 24 to the frame 12, including, without limitation, bolts, welds, screws, epoxy, or an interference fit. Also, it will be understood that the calibration ring 24 can be attached to the frame 12 either directly or indirectly. In the case of an indirect attachment, a spacer 28 may be employed to provide the proper distance between the frame 12 and the calibration ring 24. Moreover, the calibration ring 24 and frame 12 can be alternatively cast in a single piece.

As can be seen from the figures, the calibration ring 24 comprises a plate with an aperture 30 therein having a diameter of 1.3395±0.0006 inches. In a preferred embodiment, the calibration ring comprises an aluminum alloy of 7075-T6 and the ratchet wheel 20 comprises a hardened stainless steel comprising 17-4 SS or 4130 steel with a ground outer diameter 32 of 1.3411±0.0002 inches. It should be noted that other materials and dimensions can be used in the practice of the present invention and the present invention is not limited to the specific materials and dimensions described herein as a preferred embodiment. For instance, other materials than the aluminum and stainless steel of the calibration ring and ratchet wheel, respectively, can be used in the practice of the present invention. Moreover, other grades of aluminum and steel can be used. As a non-limiting example, the aluminum alloy for the calibration ring can comprise 2024-T4 or 6061-T6 aluminum. Also, the dimensions of the calibration ring and ratchet wheel can be varied to provide more or less resistance, depending on the particular application and/or preferences of the manufacturer.

In order to attach the calibration ring 24 to the ratchet wheel 20, it is preferred to use an interference fit arrangement. Using this type of arrangement, the calibration ring 24 is heated, thereby expanding the aperture 30 diameter until it can fit over the outer diameter 32 of ratchet wheel 20. In a preferred embodiment, the calibration ring is heated to approximately 360° F. until the temperature of the calibration ring is stabilized (approximately 10 minutes). The ratchet wheel 20 is then inserted into the calibration ring and then allowed to cool at room temperature. As the calibration ring 24 cools, it contracts around the ratchet wheel 20 and creates an interference fit, which gives rise to the load limiting functionality of the retractor 10. It will be appreciated that any number of process steps can be used to create the interference fit between the calibration ring and the ratchet wheel and that the present invention is not limited to the specific process steps disclosed herein. Also, it will be appreciated that the present invention is not limited to an interference fit between the calibration ring and ratchet wheel and that any other attachment scheme that will provide a load-limiting functionality can be used with the present invention.

During an accident event, the locking pawl 18 will engage one of the teeth 22 on the ratchet wheel 20, which will, in turn lock the spool 14 in place and will initially prevent belt webbing from dispensing. Subsequently, as the accident progresses, momentum from the occupant is transferred to the belt webbing, thereby loading the locked spool. However, once a certain force is generated in the form of torque applied to the spool 14 via the belt webbing, the frictional resistance (resulting from the interference fit) between the aperture 30 in the calibration ring and the outer diameter 32 of the ratchet wheel 20 will be overcome and the ratchet wheel 20 will be allowed to spin within the calibration ring 24, thereby dispensing belt webbing and limiting the load imposed on the occupant as well as the seat frame. Because there is no plastic deformation of the components of the retractor assembly in one embodiment of the invention, as is the case with a torsion bar arrangement, the retractor assembly can be reused since none of its part will have been damaged. It should however, be noted that plastically deformable components may be used in the practice of the present invention. An additional benefit with respect to one embodiment of the present invention is that it can placed in a smaller package envelope than a typical torsion bar arrangement, which may be important in aviation applications.

The foregoing description of a preferred embodiment of the invention has been presented for purposes of illustration and description, and is not intended to be exhaustive or to limit the invention to the precise form disclosed. For instance, although the belt retractor assembly of the present invention is designed for aircraft or automotive use, the present invention can be applied to any other vehicle or moving object. Thus, it is to be understood that the present invention is not limited to aircraft or automotive restraint systems, but also to other applications where it may be desired to impart load limiting functionalities to the dispensing of a web, tape, etc. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

What is claimed is:

1. An improved belt retractor assembly for use in a seat belt safety mechanism having a frame, a belt spool rotatably mounted on the frame, a pawl mounted for rotation with the spool, the retractor assembly comprising:
(a) a calibration plate mounted to the frame; and
(b) a ratchet wheel mounted on the calibration plate by interference fit for engagement with the pawl.

2. An improved belt retractor assembly for use in a seat belt safety mechanism having a frame, a belt spool rotatably mounted on the frame, a pawl mounted for rotation with the spool, wherein the retractor assembly comprises:
(a) a calibration plate attached to the frame, the plate having an opening defined by an annular surface of a first preselected diameter; and
(b) a ratchet wheel having an annular outer surface of a second preselected diameter which is less than the first preselected diameter of the opening in the calibration plate, whereby the ratchet wheel is affixed to the calibration plate by an interference fit.

3. The belt retractor of claim 2, wherein the calibration plate is directly attached to the frame.

4. The belt retractor of claim 2, wherein the calibration plate is indirectly attached to the frame.

5. The belt retractor of claim 4, wherein there is a spacer between the calibration plate and the frame.

6. The belt retractor of claim 2, wherein the spool is rotatably mounted on the frame with bearings.

7. The belt retractor of claim 2, wherein the calibration ring is rigidly mounted to the frame.

8. The belt retractor of claim 7, wherein the calibration ring is rigidly mounted to the frame with rivets.

9. The belt retractor of claim 7, wherein the calibration ring is rigidly mounted to the frame with welds.

10. The belt retractor of claim 2, wherein the calibration ring comprises an aluminum alloy.

11. The belt retractor of claim 2, wherein the ratchet wheel comprises stainless steel.

12. The belt retractor of claim 2, wherein the belt retractor is an automotive belt retractor.

13. The belt retractor of claim 2, wherein the belt retractor is an aircraft belt retractor.

14. A belt retractor comprising:
a frame, the frame including a calibration ring, said calibration ring including an aperture;
a spool rotatably attached to said frame;
a locking pawl attached to said spool;
a ratchet wheel attached to said calibration ring and located partially within said aperture in said calibration ring.

15. The belt retractor of claim 14, wherein said calibration ring is rigidly attached to said frame.

16. The belt retractor of claim 15, wherein said calibration ring is directly attached to said frame.

17. The belt retractor of claim 15, wherein said calibration ring is indirectly attached to said frame.

18. The belt retractor of claim 15, wherein said calibration ring is rigidly attached to said frame with rivets.

19. The belt retractor of claim 14, wherein the calibration ring is cast in one piece with said frame.

20. The belt retractor of claim 14, wherein the ratchet wheel is attached to said calibration ring with an interference fit.
